(19) United States
(12) Patent Application Publication
(10) Pub. No.: US 2006/0251483 A1
(43) Pub. Date: Nov. 9, 2006

(54) Anti-skid socket for screw tap

(76) Inventor: Yeo-Ching Song, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/122,095

(22) Filed: May 5, 2005

(51) Int. Cl. B23B 51/12

(52) U.S. Cl. 408/239 R

(57) ABSTRACT

Anti-skid socket for fastening to the chuck of a boring machine to hold a screw tap for allowing synchronous rotation of the screw tap with the chuck of the boring machine is disclosed to have a rectangular hole axially disposed at one end of the axial center through hole thereof for receiving the rectangular head of a screw tap, and a plurality of positioning planes spaced around the periphery thereof corresponding to the clamping elements of the chick of the boring machine for positive positioning.

### BACKGROUND OF THE INVENTION

1. Field of the Invention

The present invention relates a socket for fastening to the chuck of a boring machine to hold a screw tap for synchronous rotation with the chuck and more particularly, to an anti-skid socket, which ensures synchronous rotation of the screw tap with the chuck of the boring machine.

2. Description of the Related Art

When tapping a screw tap with a boring machine, a screw tap must be used. Because the head of a regular screw tap for fastening to a boring machine has a smooth surface, the chuck, which secures the screw tap to the boring machine, may slip over the screw tap, thereby causing the boring machine to run idle during tapping.

FIG. 6 shows a collar 42 and a chuck 4 for use in a boring machine to hold a screw tap 2. After insertion of the screw tap 2 into the collar 42, the collar 42 is fastened to the receiving hole 41 of the chuck 4, and then the chuck 4 is installed in a boring machine. The use of the collar 42 with the chuck 4 prevents idle running of the boring machine. However, the cost of the collar 42 is high.

### SUMMARY OF THE INVENTION

The present invention has been accomplished under the circumstances in view. It is one object of the present invention to provide an anti-skid socket for screw tap, which ensures synchronous rotation of the screw tap with the chuck of the boring machine, preventing idle running. It is another object of the present invention to provide an anti-skid socket for screw tap, which does not cause damage to the chuck of the boring machine. It is still another object of the present invention to provide an anti-skid socket for screw tap, which is easy and inexpensive to manufacture. It is still another object of the present invention to provide an anti-skid socket for screw tap, which prolongs the service life of the screw tap. To achieve these and other objects of the present invention, the anti-skid socket has a rectangular hole axially disposed at one end of the axial center through hole thereof for receiving the rectangular head of a screw tap, a plurality of positioning planes spaced around the periphery thereof corresponding to clamping elements of the chuck of a boring machine, and a tightening up screw adapted to hold down the screw tap inserted into the rectangular hole.

### BRIEF DESCRIPTION OF THE DRAWINGS

FIG. 1 is a perspective exploded view of an anti-skid socket and a screw tap embodying the present invention.

FIG. 2 is a perspective assembly view of FIG. 1.

FIG. 3 is a cross sectional view in an enlarged scale of a part of FIG. 2, showing the tightening up screw stopped against the periphery of the screw tap.

FIG. 4 is an exploded view the anti-skid socket, the chuck of a boring machine, and a screw tap according to the present invention.

FIG. 5 is an applied view of the present invention, showing a screw tap fastened to the anti-skid socket and the anti-skid socket fastened to the chuck of a boring machine.

FIG. 6 is an exploded view of the prior art design.

### DETAILED DESCRIPTION OF THE PREFERRED EMBODIMENT

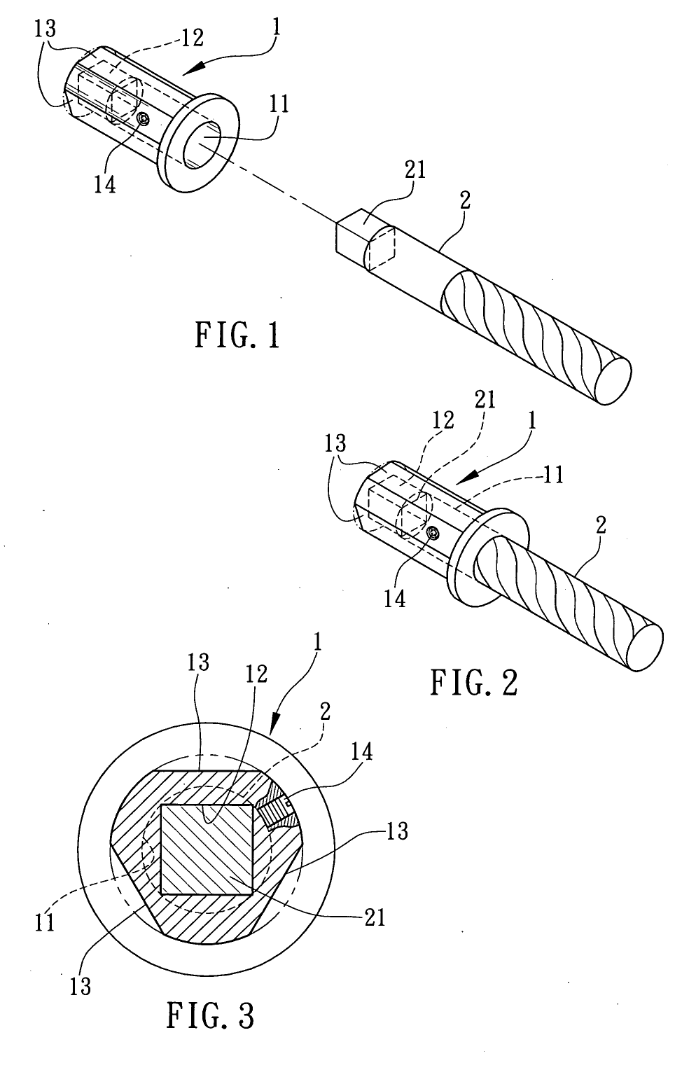

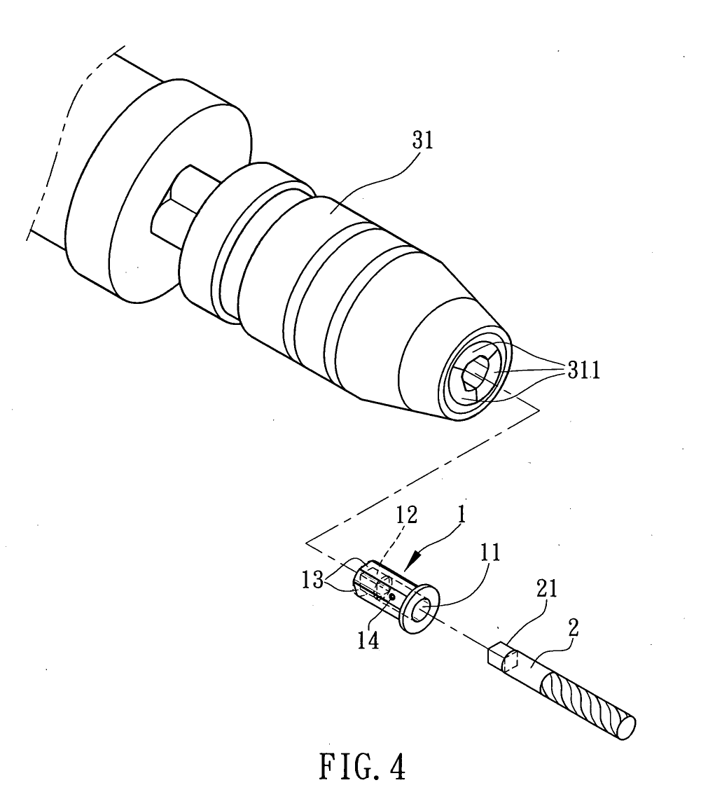

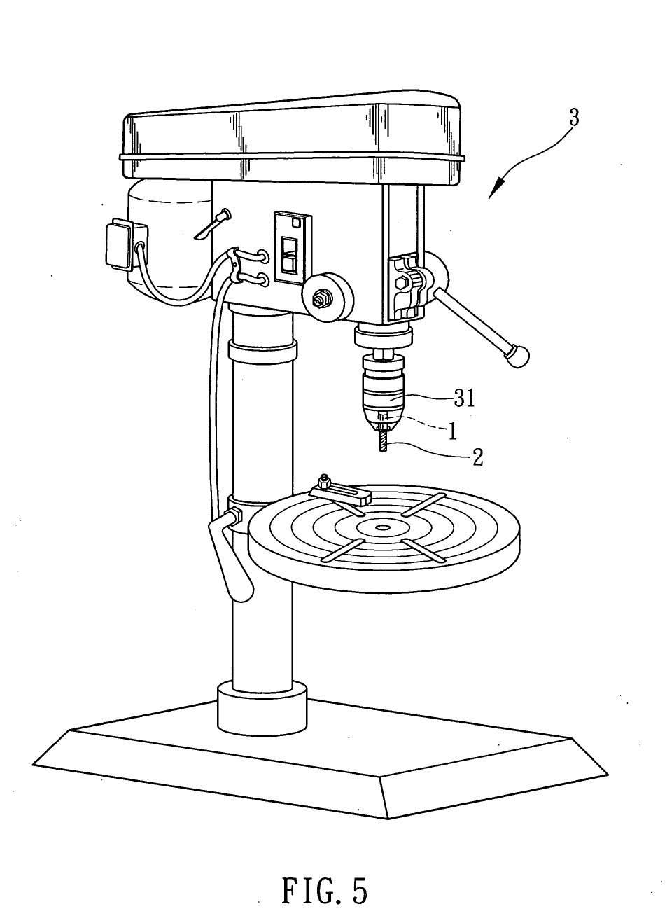

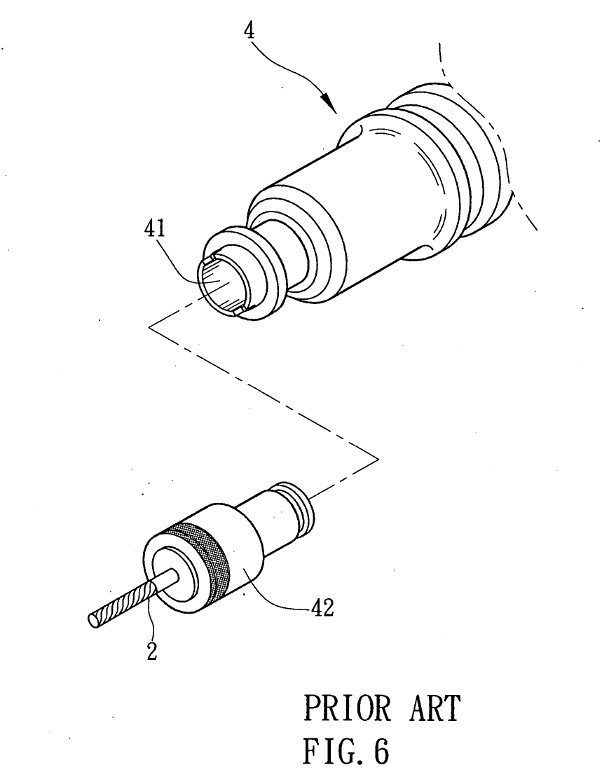

Referring to FIGS. 1-5, an anti-skid socket 1 is shown having an axial center through hole 11, a rectangular hole 12 at one end of the axial center through hole 11 for receiving the rectangular head 21 of a screw tap 2, and a plurality of positioning planes 13 spaced around the periphery corresponding to the clamping elements 311 of the chuck 31 of a boring machine 3. When the anti-skid socket 1 is inserted into the chuck 31 of the boring machine 3, the clamping elements 311 of the chuck 31 are respectively clamped on the positioning planes 13, and then the chick 31 of the boring machine 3 is locked to secure the anti-skid socket 1 firmly in place for synchronous rotation with the chuck 31. Further, the anti-skid socket 1 is provided with a tightening up screw 14. After insertion of the screw tap 2 into the axial center through hole 11 to force the rectangular head 21 into the rectangular hole 12, the tightening up screw 14 is rotated inwards and stopped against the periphery of the screw tap 2 to secure the screw tap 2 to the anti-skid socket 1 firmly for synchronous rotation with the chuck 31 of the boring machine 3.

A prototype of anti-skid socket for screw tap has been constructed with the features of FIGS. 1-5. The anti-skid socket for screw tap functions smoothly to provide all the features discussed earlier.

Although a particular embodiment of the invention had been described in detail for purposes of illustration, various modifications and enhancements may be made without departing from the spirit and scope of the invention. Accordingly, the invention is not to be limited except as by the appended claims.

1. An anti-skid socket for adapting the chuck of a boring machine to hold a screw tap having a rectangular head formed thereon, the anti-skid socket comprising:
a socket having an axial center through hole at one end of which the screw tap is inserted, the through hole having a rectangular hole axially formed at an end thereof opposite the end in which the screw tap is inserted and receiving the rectangular head of the screw tap; and
a plurality of positioning planes spaced around a periphery of the socket between the rectangular hole and the end of the socket in which the screw tap is inserted the positioning planes corresponding to clamping elements of the chuck of the boring machine.

2. The anti-skid socket as claimed in claim 1, wherein the socket includes a tightening up screw threadedly received in one of the positioning planes and applying a retaining force on the screw tap inserted into the through hole.
